(19) United States
(12) Patent Application Publication
(10) Pub. No.: US 2009/0040643 A1
(43) Pub. Date: Feb. 12, 2009

(54) METHOD AND APPARATUS FOR WRITING TIMING BASED SERVO TRACKS ON MAGNETIC TAPE USING COMPLEMENTARY SERVO WRITER PAIRS

(75) Inventors: Ming-Chih WENG, Los Angeles, CA (US); Turguy Goker, Solana Beach, CA (US); Jerry Hodges, Riverside, CA (US); John Koski, Lafayette, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 12/174,544

(22) Filed: Jul. 16, 2008

Related U.S. Application Data
(60) Provisional application No. 60/961,313, filed on Jul. 19, 2007.

(51) Int. Cl. G11B 5/02

(52) U.S. Cl. 360/55; G9B/5.026

(57) ABSTRACT

Method and apparatus for writing timing based (servo) tracks on magnetic recording tape using complementary servo writer pairs. A magnetic tape intended to store, for instance, computer data conventionally contains servo tracks in addition to the data tracks. Typically many servo tracks and data tracks are arranged laterally across the width of the tape. The adjacent servo tracks (bands) here are complementary in terms of the orientation of their stripes and are written (recorded) by a complementary arranged servo writer pair. This advantageously reduces the position error signal by a substantial amount, even to nearly zero. In one version the servo writers are straight in configuration and in another version they are curved or chevron shape. These complementary servo writer pairs write adjacent servo bands. This takes advantage of the fact that typical servo technology, for instance in the LTO tape format, uses two servo heads, a top and bottom servo head, and averages the position error signal of the top and bottom servo read heads in the tape drive to determine the position error. By writing the servo tracks as described here, this error as written-in is substantially reduced. This is because the top and bottom servo sensors interpret the complementary aspect as being position error signal error in opposite directions, which thereby cancels out.

### CROSS REFERENCE TO RELATED APPLICATION

This application claims priority to U.S. provisional application 60/961,313, filed Jul. 19, 2007 incorporated herein by reference in its entirety.

### FIELD OF THE INVENTION

This disclosure relates to magnetic media recording, to magnetic recording tape drives, and to servo (read/write head positioning) techniques for tape drives.

### BACKGROUND

A position feedback (“servo”) signal when read by a magnetic recording head in a tape drive from timing data recorded on magnetic recording tape generates an error signal that describes the relative motion between the head and the Lateral Tape Motion (LTM) in the tape drive. This error signal is commonly referred as the PES (Position Error Signal). Current “LTO” format (Linear Tape Open) magnetic recording tape has embedded magnetic timing stripes that are decoded by LTO tape drives to generate a linear PES signal, which is used to track the LTM that results in correct placement of data tracks on tape as defined by the tape format. (LTO is an industry standard format in the magnetic tape field.)

LTO specifies a ½″ tape width. It is intended for large amounts of data storage. There are typically 384 to 896 tape tracks, and the tape drive has 8 or 16 write elements. The tracks occur in groups, with four data bands interspersed between five servo (positioning) bands. The tape drive read/write heads straddle the two servo bands that border the data band being written or read. Usually the servo tracks are written onto the tape when the LTO tape cartridge is manufactured. The servo mechanism in the tape drive constantly moves the read/write head to keep it on the data track. The head includes special sensors that monitor (read) the servo tracks, to provide the read/write head positioning. LTO tapes are housed in cartridges having a specified form factor.

The LTO format, as shown in FIGS. 1 to 4, has a series of 18 timing stripes all with +/−6 degrees of azimuth angle written in a specific format, having a set of A, B, C and D stripes. The LTO format specifies the accuracy of the servo writing by specifying critical physical dimensions that will result in precise PES decoding to measure RHP (Relative Head Position).

As described in the LTO Format Specification, the PES is defined as the ratiometric timing difference between the sets of A, B, C and D stripes as shown below. Since the format defines the A to C and C to A distance as 100 μm±0.25 μm over 7.2 mm of longitudinal distance, this uncertainty results in a calculation error which limits the performance of the tape drive's servo tracking system.

U.S. Pat. No. 6,842,305 B2, Imation and U.S. Pat. No. 6,879,457 B2, IBM modify the servo writing of two stripes simultaneously to servo writing of three or more stripes simultaneously to make sure the dimensional accuracy within a servo frame. A disadvantage of these methods is that the dimensional accuracy between the adjacent frames is still subject to servo writer speed variation. This selection of an inaccurate dimension becomes unusable and in turn introduces time delay.

U.S. Pat. No. 6,842,305 B2 uses a three-stripe writer to stamp all three-servo signals together to generate a new N pattern, that makes the denominator constant and hence has no written in PES error due to servo writer variation. The result of this process is a different servo pattern than the LTO format. Also it requires three bursts to create one PES signal, which introduces more time delay than current LTO format. Furthermore, it does not improve the PES detection error due to tape drive speed variation while reading this servo pattern.

U.S. Pat. No. 6,879,457 B2 describes a quite similar method of servo writing technology that results in a constant denominator. The result of this process is a different servo pattern than that of the LTO format, such as the new 5-5-5-5-4-4-4-4 pattern, and the LPOS needs to be encoded in all the five stripe bursts. Although it looks similar to the current LTO format, it is completely different in terms of the detection algorithm, and undesirably requires a read circuit hardware (ASIC) redesign of the tape drive in order to be compliant.

### SUMMARY

The present method is directed to a tape servo track format that reduces the PES calculation error due to servo writer speed variation and tape drive speed variation, in order to achieve high track densities for future generations of tape drives with a minimal modification, or without changing the current defined LTO (or other) format and assuring adequate PES samples per frame without introducing time delays.

This disclosure is directed to a method of servo writing and the associated servo writing apparatus that reduce this calculation error by, e.g., 77% by using a straight complementary servo writer pair, or to nearly zero by using a curved complementary servo writer pair. In one embodiment, the method writes a servo track format very similar to the conventional LTO format, therefore making it useable by conventional PES detection ASIC (Application-Specific Integrated Circuit) devices as now used in tape drives. In another embodiment, the method writes the current LTO servo track format, with a suitable modification of the servo writer electronics.

Another advantage of the present complementary servo writing method is that it not only reduces the PES detection error due to the servo writing variations, but it also reduces the PES detection error due to the tape drive read speed error by a factor of 10.

The present method does not require dimensional accuracy between adjacent servo frames, therefore it improves the PES calculation error without introducing time delay, unlike prior methods. Another disadvantage of prior methods is that they only improve PES detection error due to servo writer speed variation, and do not improve the PES detection error due to the tape drive speed variation.

U.S. Pat. No. 7,102,846 B2, to IBM and U.S. Pat. No. 7,139,151 B2, to Imation show use of inverted servo patterns at a pair of adjacent servo bands to distinguish it from the other pair of adjacent servo bands, such that the tape drive places the read/write element at the correct data band. In accordance with the present invention, the servo writer instead has complementary servo writer pairs for adjacent servo bands, which need not be straight stripes, need not be inverted gaps, and may have an offset such that the resulting written servo patterns for adjacent servo bands look exactly the same.

Also provided is a servo writer head with curved or chevron-shaped heads that writes chevron-shaped servo patterns. A particular spacing is provided between the corresponding servo readers (read heads) in the tape drive.

Also provided here are alternative servo write head configurations and servo track read methods that completely remove the PES calculation error due to servo writer speed variations. These alternatives may use servo track formats and detection methods that are different than the LTO format and detection methods, but retain the peak-detection channel core of the LTO format. While these alternatives may require additional detection channel modifications to implement, they provide the advantage of completely removing servo writer speed variation in the calculated PES.

Also disclosed here is the corresponding method of reading the present servo patterns, a servo writer apparatus including a suitable write head, the corresponding tape drive, and the resulting tape product (e.g., tape cartridges) with the servo tracks written thereon. It is to be understood that in one embodiment, the servo patterns are written (recorded) onto the tape when the tape cartridge is manufactured, before the tape cartridge is in use.

### BRIEF DESCRIPTION OF THE DRAWINGS

FIG. 1 shows in the prior art the conventional servo band locations and the relative positions of the servo frames and how they determine the band identification.

FIG. 2 shows the prior art LTO servo frames, with the 5-5-4-4 pattern used to determine if the PES detection is valid.

FIG. 3 shows in the prior art servo framing and coding.

FIG. 4 shows in the prior art LTO data bands.

FIG. 5 shows in the prior art the written-in PES error caused by servo writer speed variation.

FIG. 6a shows a conventional servo writer head and FIG. 6b shows the conventional written servo frames on a tape.

FIG. 7 shows a prior art servo writer and how it writes identical servo frames for the top and bottom servo bands.

FIG. 8a shows in accordance with the invention the present servo writer head and FIG. 8b shows the corresponding written servo frames on a tape.

FIG. 9 shows the present servo writer and how it writes identical servo frames for top and bottom servo bands.

FIG. 10 shows graphically a comparison of written-in PES noise using the prior art approach and in accordance with the present invention.

FIG. 11a shows another version of the present servo writer head which is split and FIG. 11(b) shows a corresponding servo frame the same as a conventional LTO format.

FIG. 12a shows another version of a servo writer in accordance with this invention having a mirror image arrangement and FIG. 12b shows a corresponding servo frame.

FIG. 13a shows another example of a servo writer in accordance with the invention and FIG. 13b shows a corresponding servo frame.

FIGS. 14a-14h show other examples of complementary servo writer pairs in accordance with the invention.

FIGS. 15a-15c show further examples of complementary servo writer pairs to cancel written-in PES error from writer speed variation.

FIG. 16a shows a configuration of a curved servo stripe in accordance with the invention and FIG. 16b shows a curved servo stripe for a bottom servo frame in accordance with the invention compared with a straight stripe.

FIG. 17 shows graphically the written-in PES error using curved servo stripes in accordance with the invention.

FIG. 18 shows in the top part of the figure curved servo stripes for a top servo frame and in the bottom portion of the figure for a bottom servo frame.

FIG. 19 shows graphically performance in terms of written-in PES error from servo writer speed variation comparing the prior art to that in accordance with the present invention.

FIG. 20a shows a servo writer using curved servo writer pairs and FIG. 20b shows the corresponding servo frame.

FIG. 21a shows curved servo writers which are offset and FIG. 21b shows the corresponding servo frame.

FIGS. 22a to 22c show graphically PES error for respectively the top track, middle track, and bottom track due to a 1% servo writing speed variation.

FIGS. 23a to 23c show graphically PES error for respectively the top track, middle track, and bottom track all due to a 1% tape drive speed variation.

FIG. 24a shows a three stripe servo writer in accordance with the invention; FIG. 24b shows the corresponding servo frame.

FIGS. 25a to 25c show PES error due to 1% tape drive speed variation for respectively the top track, middle track, and bottom track.

FIG. 26a shows a chevron shaped servo writer head in accordance with the invention and FIG. 26b shows the corresponding servo frame.

FIG. 27 shows how the present servo track is read with two readers using an adjacent pair of the three readers of FIG. 26a.

FIG. 28 shows graphically comparison of the written-in PES noise for the prior art and in accordance with the invention.

FIGS. 29a-29e show examples of complementary writer pairs using other than straight servo writers.

FIGS. 30a to 30c show further examples of servo writers that are other than straight.

FIG. 31 shows how using a chevron pattern in two readers the PES ratio is calculated.

FIG. 32 shows a modified chevron pattern in accordance with the invention and how the PES ratio is calculated.

FIG. 33 shows using the conventional LTO servo pattern with a complementary servo reader pair how the PES ratio is calculated.

FIG. 34 shows on the top portion a top servo pattern and on the bottom portion a bottom servo pattern for a VII pattern.

FIG. 35 shows a VI pattern with three stripes stamped together with three different azimuth angles.

FIG. 36 shows an IVI pattern with four stripes stamped together.

### DETAILED DESCRIPTION

### Complementary Servo Writer Pairs

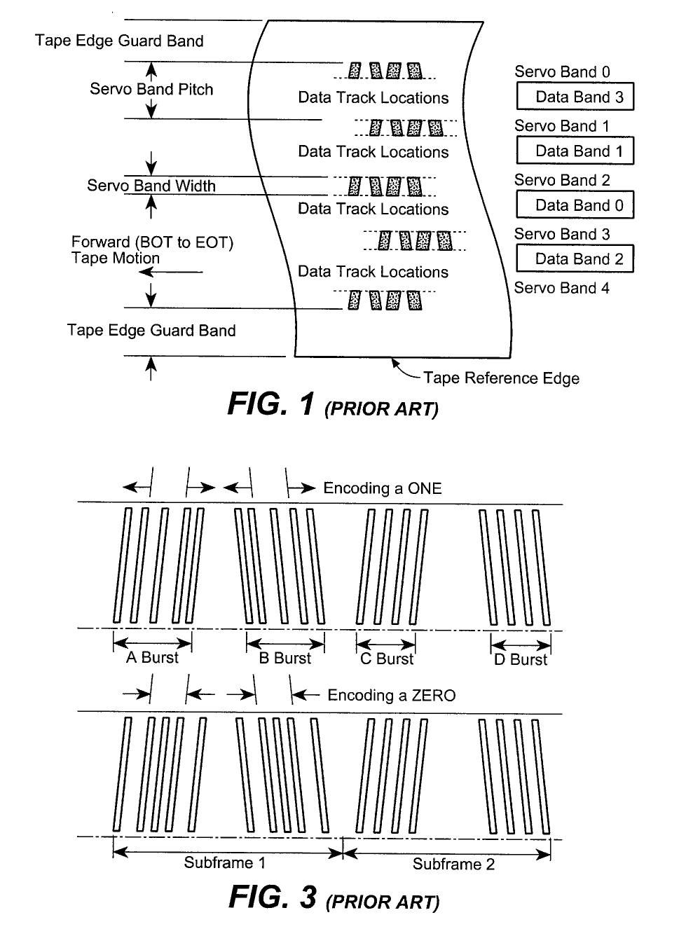

The LTO format specifies a group of five servo bands and four data bands across the magnetic tape and between the adjacent servo bands. The LTO servo band locations are shown in FIG. 1. FIG. 1 (illustrating in a plan view a short length of magnetic tape and only part of the tape width) also shows the band ID feature that is determined by the relative positions down the tape of the two adjacent servo bands, see U.S. Pat. No. 6,169,640 incorporated herein by reference in its entirety.

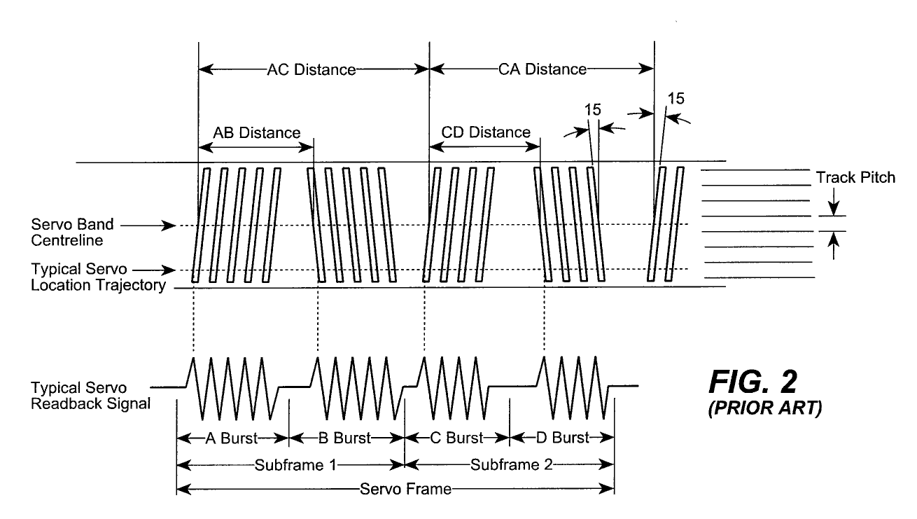

LTO utilizes a timing based servo method (see U.S. Pat. Nos. 3,686,649, 5,689,384 incorporated herein by reference in their entireties), and the servo frame (on the tape) includes A, B, C, and D bursts as shown in FIG. 2 showing the servo pattern and corresponding signal as a waveform. The Position Error Signal (PES) is calculated by using the ratio such as AB/AC or CD/CA. The denominator can be AC, BD, CA, DB, and is supposed to be a constant of 100 um. The numerator can be AB, BC, CD, DA. By doing so, the calculated PES is insensitive to the LTO drive speed variation. FIG. 2 also shows the feature of 5-5-4-4 numbers of stripes for the A-B-C-D burst. This 5-5-4-4 feature is used to detect if the detected PES signal is valid.

FIG. 3 shows another feature of the conventional LTO servo format: servo frame encoding (see U.S. Pat. No. 5,930,065 incorporated herein by reference in its entirety). The A and B bursts have the 2nd and 4th stripes moving further apart or closer to encode a “ONE” or a “ZERO.” These encoded bits store the tape longitudinal position (LPOS) along the whole length of tape.

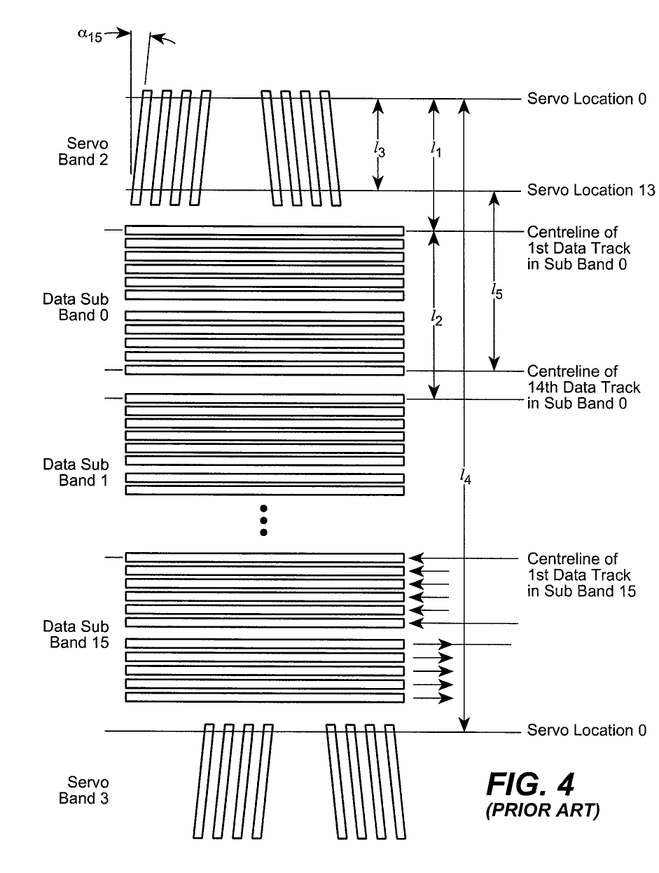

An LTO format tape drive conventionally has a top servo sensor (also referred to as a head or transducer) and a bottom servo sensor, and has data read/write elements (heads or transducers) located between the two servo sensors. The two servo sensors will detect PES from the servo band (n) and servo band (n+1), and write/read data tracks between the two servo bands, as shown in FIG. 4.

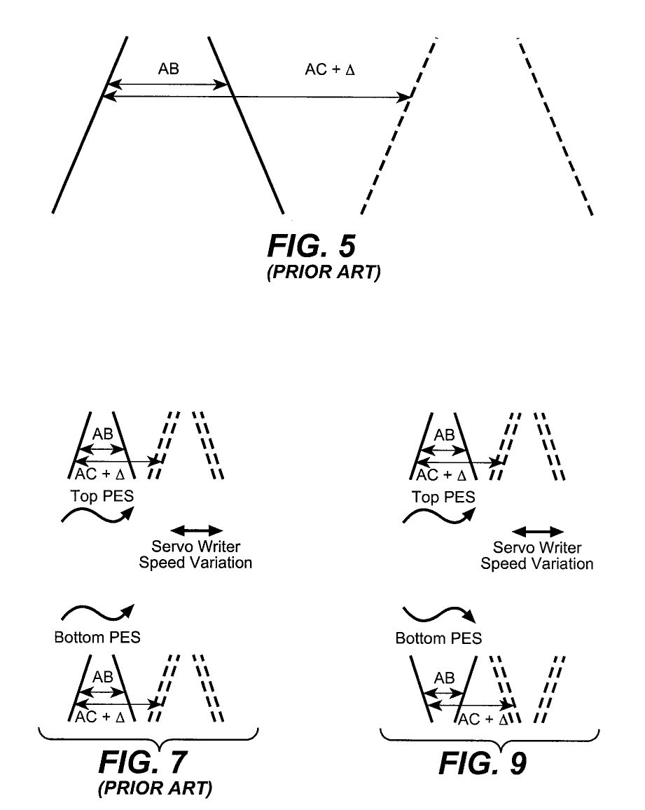

From the current LTO tape measurement, there is a written-in PES error that has a standard deviation of around 0.13 μm. To enable higher track densities for future generations of tape storage, one needs to resolve this undesirable written-in PES error. A major part of written-in PES error is due to the servo writer speed variation. As shown in FIG. 5, the conventional servo writer apparatus stamps (writes) the A and B bursts together on the tape, and then the C and D bursts together, and so on. The tape speed variation at the servo writer will result in an error in the denominator that is supposed to be 100 μm. If there is a speed variation of 1%, the detected PES will be off by 1.7 to 3.1 μm for the top and bottom tracks respectively.

The present method takes advantage of the fact that the LTO format uses two servo read (sensor) heads, the top servo head and bottom servo head, and uses the average of the top and bottom head PES to determine the position error. The present method uses a servo write method that can cancel the servo writer speed variation when one averages the top and bottom PES.

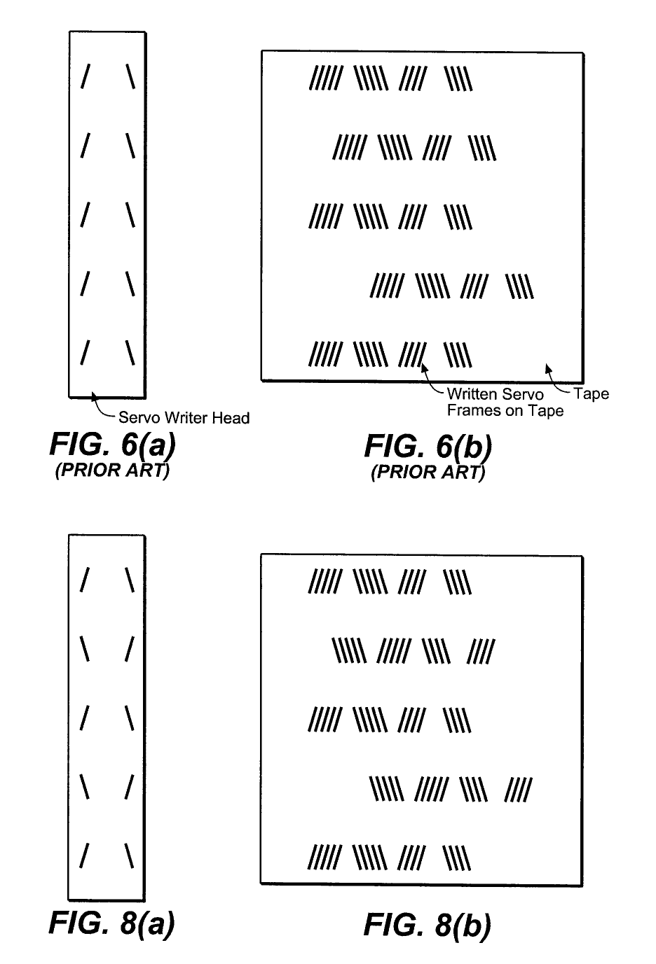

FIG. 6a shows in a simplified plan view the conventional servo writer head that is currently used to write such LTO servo frames on tape and the corresponding servo pattern is shown in FIG. 6b. (Only the location and shape of the write elements are shown.) FIG. 7 shows graphically that the tape speed variation of this servo writer will undesirably cause variations of the distances between servo sub-frames. When the tape drive reads this tape, both the top and bottom servo will decode such speed variation as PES variation. For LTO servo, the average PES becomes:

$$\begin{matrix}{PES}_{Average} = {PES}_{Top} \\ = {PES}_{Bottom} \\ = ( 0.5 - \frac{AB}{AC + Δ} ) \times 475.718 \\ \approx ( 0.5 - \frac{AB}{A C} + \frac{AB}{A C} \cdot \frac{Δ}{A C} ) \times 475.718\end{matrix}$$

(0.5−AB/AC)×475.718 is the actual position error. AB/AC is a ratio ranging from 0.35 to 0.65. Δ/AC is the servo writer speed variation. The resulting PES error caused by servo writer speed variation is (AB/AC)×(Δ/AC)×475.718 μm. For 1% speed variation, the error is 1.7-3.1 μm.

FIG. 8a shows in a similar simplified view the configuration of one embodiment of the present servo writer head, and in FIG. 8b one of the servo frames (pattern) that it writes (records) on the tape. The present servo writer is otherwise conventional in terms of its configuration and construction and as usual in addition to the write head includes the associated signal processing circuitry and tape drive mechanism. FIG. 9 shows graphically the benefit of writing the servo frames using this servo writer. When this servo writer writes the servo frames with speed variation, the top and bottom servo sensors will interpret it as PES error in the opposite directions. After the tape drive servo signal processing averages the top and bottom servo signals, this written-in PES error caused by servo writer speed variation is canceled when the tape is used in the tape drive:

$${PES}_{Top} = ( 0.5 - \frac{AB}{A C + Δ} ) \times 475.718 , \\ \begin{matrix}{PES}_{Average} = ( \frac{{AB}^{′} - AB}{2 ( A C + Δ )} ) \times 475.718 \\ \approx ( \frac{{AB}^{′} - AB}{2 \cdot A C} - \frac{{AB}^{′} - AB}{2 \cdot A C} \cdot \frac{Δ}{A C} ) \times 475.718 ( µm )\end{matrix}$$

(AB′−AB)/2AC×475.718 is the actual position error. (AB′−AB)/2AC is a ratio ranging from −0.15 to 0.15. Δ/AC is the servo writer speed variation. The resulting PES error caused by servo writer speed variation is −(AB′−AB)/2AC×(Δ/AC)×475.718 um. For 1% speed variation, the error is −0.7-0.7 μm. Notice that at the center track where AB/AC=0.5, the PES error is 0. The comparison of this written in PES error of this invention to that of the conventional LTO format is shown graphically in FIG. 10.

Although this servo format, shown in FIG. 8b, looks quite different from the conventional LTO format, it actually operates very similar in terms of servo detection (being read). In other words, the ASIC hardware design (circuitry) of the servo reader in the tape drive does not need to be changed from what it is conventionally, so it can still detect the ratio, the 5544 pattern, the LPOS encoding, and the top-bottom servo timing for band ID. Any required changes are, e.g., in the firmware (instructions) of the LTO tape drive, which can be easily modified to average the PES in a different manner, and to determine the band ID differently by including the actual PES value.

FIG. 11a shows another embodiment of this servo writer with the resulting servo frame in FIG. 11b. If the servo writer head is effectively split into half as shown in FIG. 11a and each of the two writer elements is energized independently, one is able to write the exact conventional LTO format without any modification. In this embodiment the servo writer circuitry must energize the left and right servo stripes independently to generate the 5544 pattern and LPOS encoding. The benefit of reducing written-in PES error is the same as described above. As shown in FIG. 11b, one then uses (AC+Δ−AB′) as the PES numerator instead of AB′, and the averaged PES has the same form as the previous embodiment. The written in PES comparison of this embodiment to the conventional LTO format is represented by FIG. 10.

$${PES}_{Top} = ( 0.5 - \frac{AB}{A C + Δ} ) \times 475.718 , \\ {PES}_{Bottom} = ( 0.5 - \frac{AC + Δ - {AB}^{′}}{A C + Δ} ) \times 475.718$$

$$\begin{matrix}{PES}_{Average} = ( \frac{{AB}^{′} - AB}{2 ( A C + Δ )} ) \times 475.718 \\ \approx ( \frac{{AB}^{′} - AB}{2 \cdot A C} - \frac{{AB}^{′} - AB}{2 \cdot A C} \cdot \frac{Δ}{A C} ) \times 475.718 ( µm )\end{matrix}$$

A feature of the present servo writing method is that the adjacent servo bands are written in a way such that one servo band is written with a fixed numerator (for example, AB), and the other servo band is written with a fixed (denominator−numerator) (for example, AC−AB). In other words, the two adjacent servo band writers are complementary. From this point of view, the following discloses additional embodiments of this servo writing method.

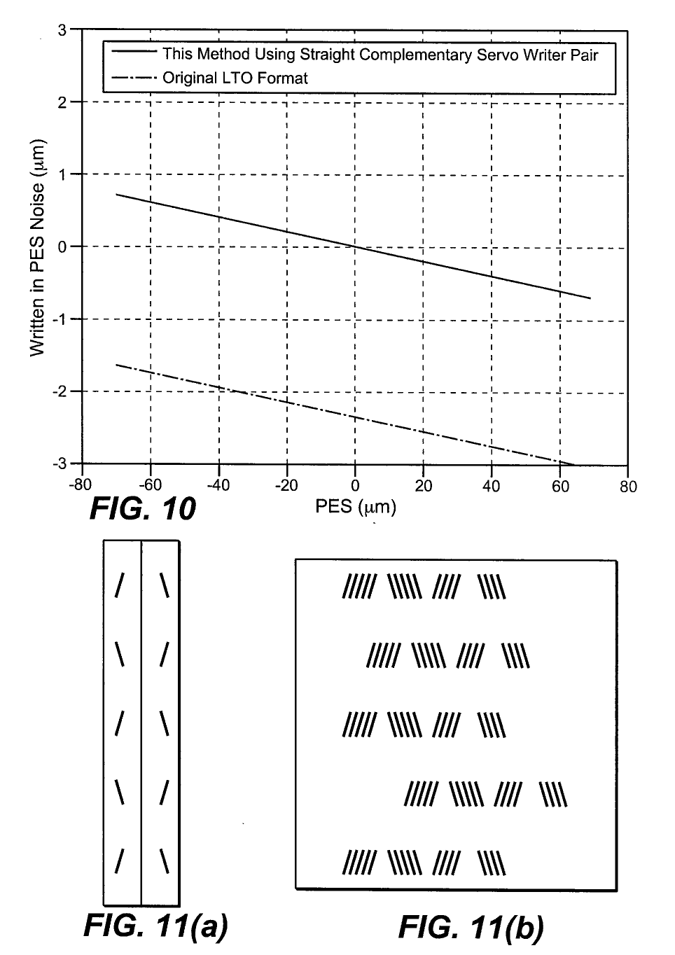

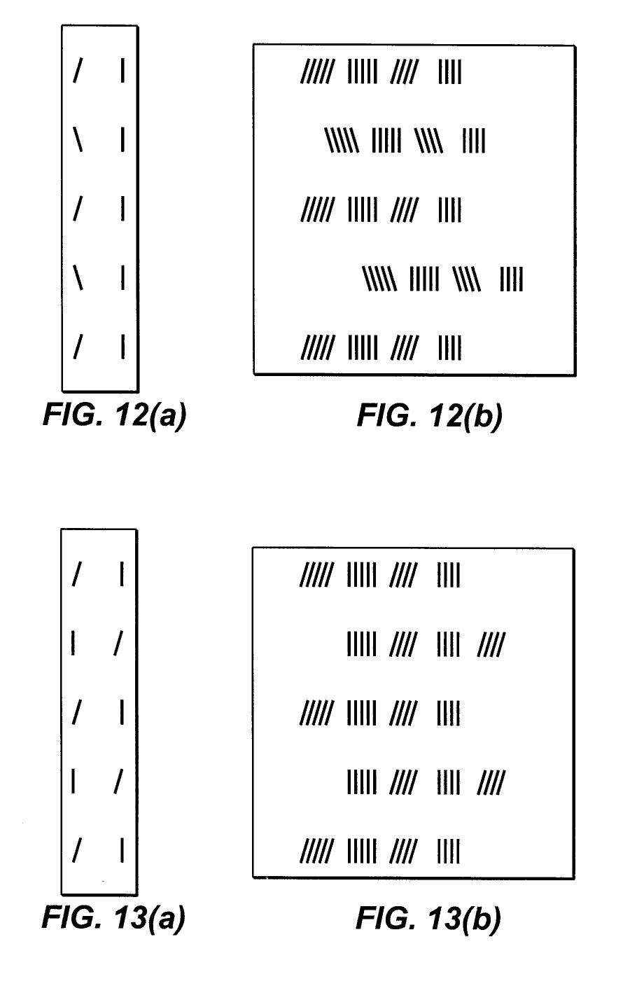

FIG. 12a shows a servo writer and accompanying patterns (see FIG. 12b) that writes servo frames using the present method, where the adjacent servo band writers are mirror images in the vertical (cross-tape) direction. FIG. 13a shows similarly another servo writer that writes servo frames (see FIG. 13b) using the present method, where the adjacent servo band writers are mirror images in both the vertical and horizontal (tape movement) directions. In both examples, the adjacent servo bands are written by writers that are complementary to each other, in other words, one writer stamps AB simultaneously, the other writer stamps (AC−AB) simultaneously.

The embodiment of FIGS. 13a, 13b shows features from U.S. Pat. No. 7,102,846 B2, and U.S. Pat. No. 7,139,151 B2. In accordance with the present method, the adjacent servo writers are not necessarily of an inverted pattern, and the adjacent written servo patterns are not necessarily an inverted pattern.

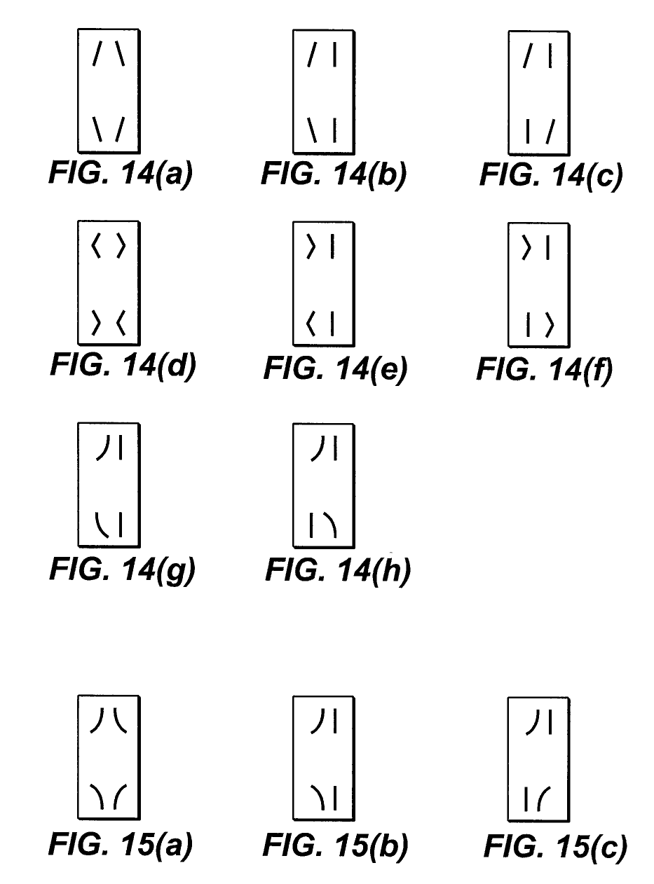

FIGS. 14a to 14h show more examples of the present complementary writer pairs (omitting the resulting servo patterns). Notice that for the FIGS. 14d to 14f examples that have “elbow” or curved shape writers, if one sets AB=BC=50 μm at the ¼ and ¾ height, the written-in PES noise can be further reduced by ½. For the examples using a curved writer, the PES calculation gain is not a constant from top to bottom track, but is the same for top and bottom servo heads. Some of the examples shown here (examples FIGS. 14a, 14c, 14d, 14f, 14h) can write identical servo frames at adjacent servo bands if the servo writer head is split into half and energize the left writer element and right writer element independently, similar to FIG. 11.

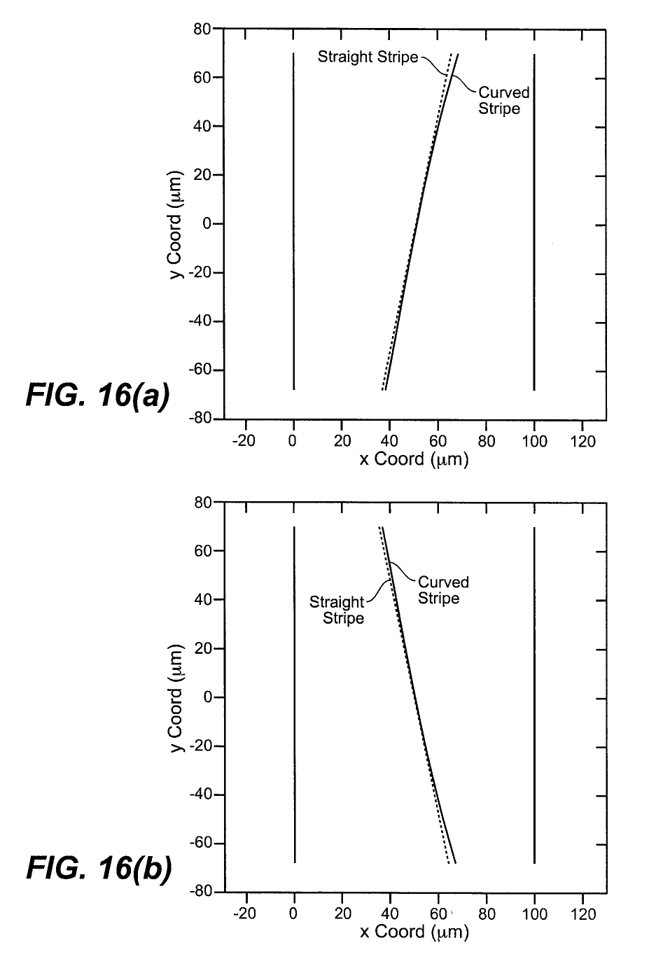

FIGS. 15a to 15c show additional examples of modified complementary writers. Notice the similarity to the examples in FIGS. 16a, 16b, and 16c. The straight stripes are intentionally curved in an attempt to cancel all written-in PES error caused by servo writer speed variation. The drawback is that the PES calculation gain is not a constant from top to bottom tracks.

FIGS. 15a to 15c show how the present approach differs from that of U.S. Pat. No. 6,842,305. In that patent, there is an embodiment of a three stripe servo pattern with two straight reference pattern lines and one curved track pattern line. In accordance with the present invention, both stripes may be curved, and the curve is specifically designed to cancel the written-in speed variation.

FIGS. 16a and 16b show an example of the present curved servo stripe (respectively for the top and bottom frames) to cancel the written-in PES noise. The curves are generated by the following 2nd order polynomial equations:

Top Curve: y=−0.045×(x−50)²+4.75718×(x−50) (μm)

Bottom Curve: y=0.045×(x−50)²−4.75718×(x−50) (μm)

The associated PES is calculated by the following 2nd order polynomial equations:

PES_{Top}=−450×(0.5−Ratio_{Top})²+475.718×0.5−Ratio_{Top}) (μm)

PES_{Bottom}=450×(0.5−Ratio_{Bottom})²−475.718×(0.5−Ratio_{Bottom}) (μm)

In this configuration, the original straight inclined stripe has a 11.9 degree tilt, and the modified curve ranges from 9.3 degree tilt at one end to 16.4 degree tilt at the other end, with 11.9 degree in the middle.

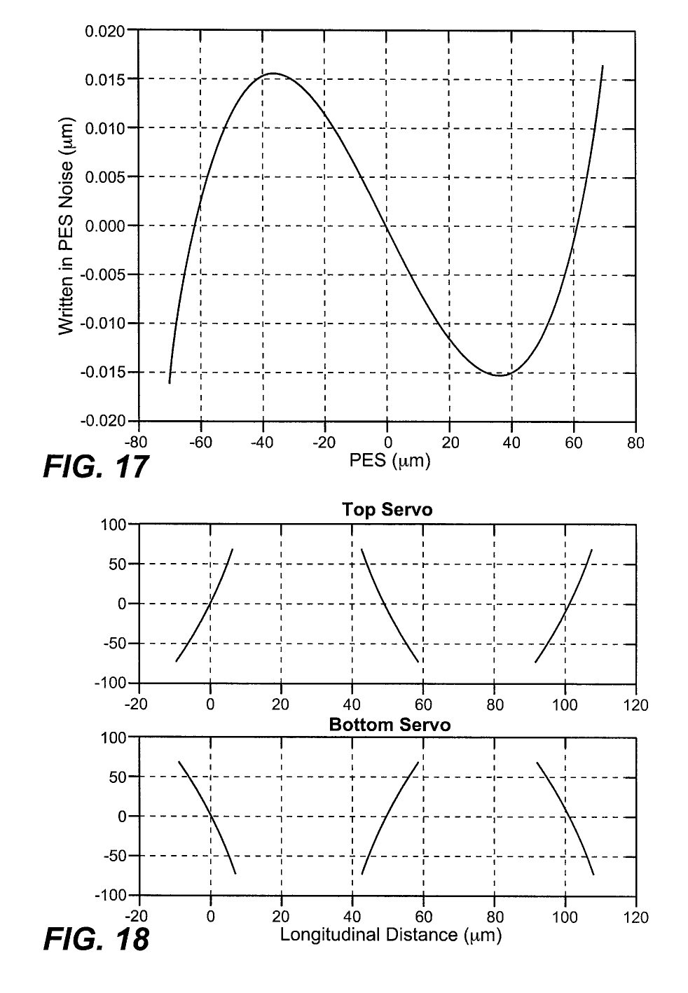

The calculated result shows that the written-in PES error can be further reduced from 0.7 μm to 0.02 μm by using this modified curve, as shown graphically in FIG. 17.

FIG. 18 shows another configuration of a curved stripe servo pattern (frame) that cancels the written-in PES noise where the top part of the figure is for the top servo frame and the bottom part is for the bottom servo frame. The curves and the associated PES are defined by 2^{nd} order polynomials:

Top 1st Curve: y=0.18×x²+9.51436×x, 2nd Curve: y=0.18×(x−50)²−9.51436×(x−50)

Bottom 1st Curve: y=−0.18×x²−9.51436×x,

2nd Curve: y=−0.18×(x−50)²+9.51436×(x−50)

PES_{Top}=450×(0.5−Ratio_{Top})²+475.718×(0.5−Ratio_{Top}) (μm)

PES_{Bottom}=−450×(0.5−Ratio_{Bottom})²−475.718×(0.5−Ratio_{Bottom}) (μm)

The resulting written-in PES error from FIG. 18 is exactly the same as the configuration of FIG. 16, and is shown by FIG. 17.

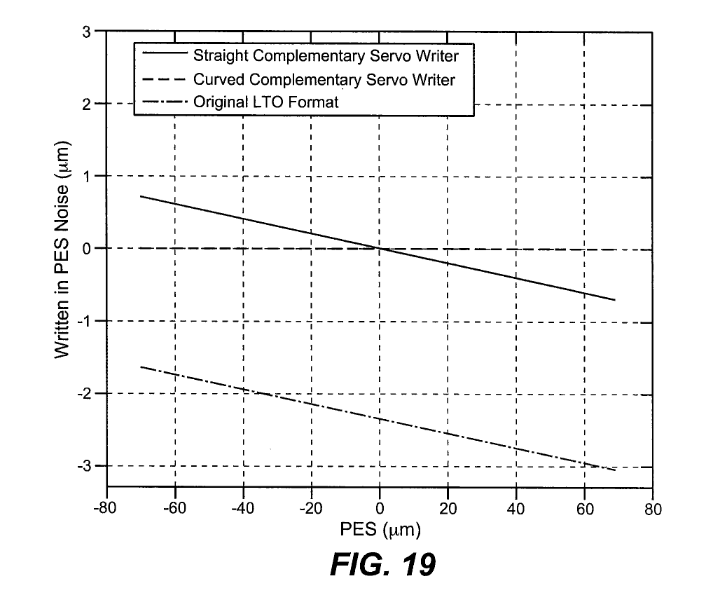

FIG. 19 shows graphically the written-in PES error from 1% servo writer speed variation for (1) the original LTO format, (2) the straight complementary servo writer pairs, and (3) the modified curved complementary servo writer pairs.

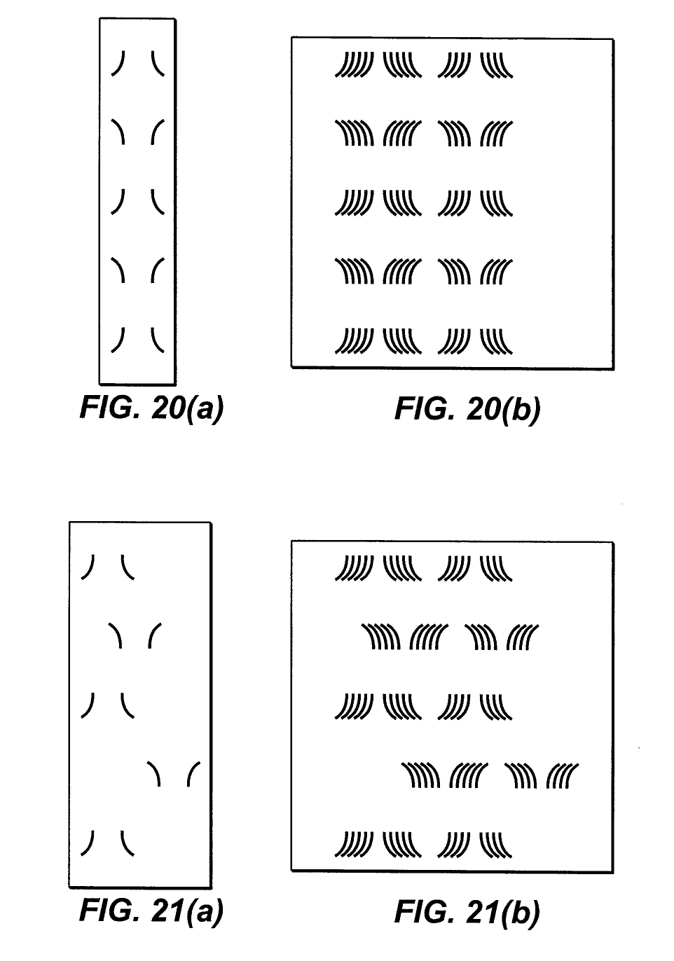

In FIG. 18, the top and bottom servo frames are shown without the band ID shift. However, the top and bottom servo frames can be stamped with the band ID shift if desired as described in the LTO Ultrium Format Specification or similarly in U.S. Pat. No. 6,169,640. The disadvantage of stamping the top and bottom servo frames with the band ID shift is that the servo writer speed error could be different between the time stamping top servo and the time stamping bottom servo. To better cancel the servo writer speed variation, one can stamp the top and bottom servo simultaneously without the band ID shift as shown in FIG. 20a, illustrating the servo writers and resulting patterns in FIG. 20b and determine the band ID by detecting the different geometry of the top and bottom servo such as in U.S. Pat. No. 7,102,846. Another way to cancel the servo writer speed variation is to use a servo writer with longitudinal offset between adjacent servo bands, and stamp the top and bottom servo bands simultaneously as shown in FIGS. 21a, 21b.

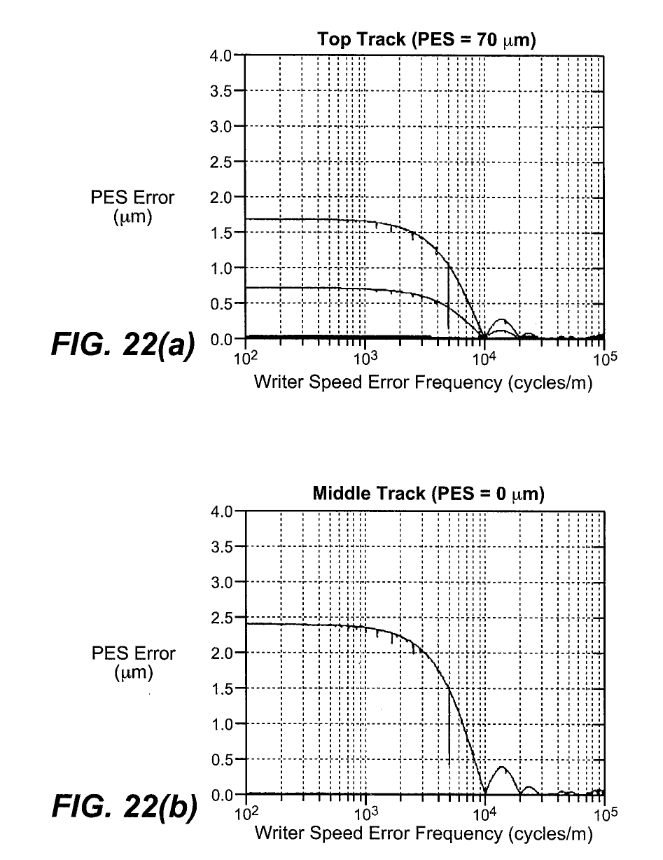

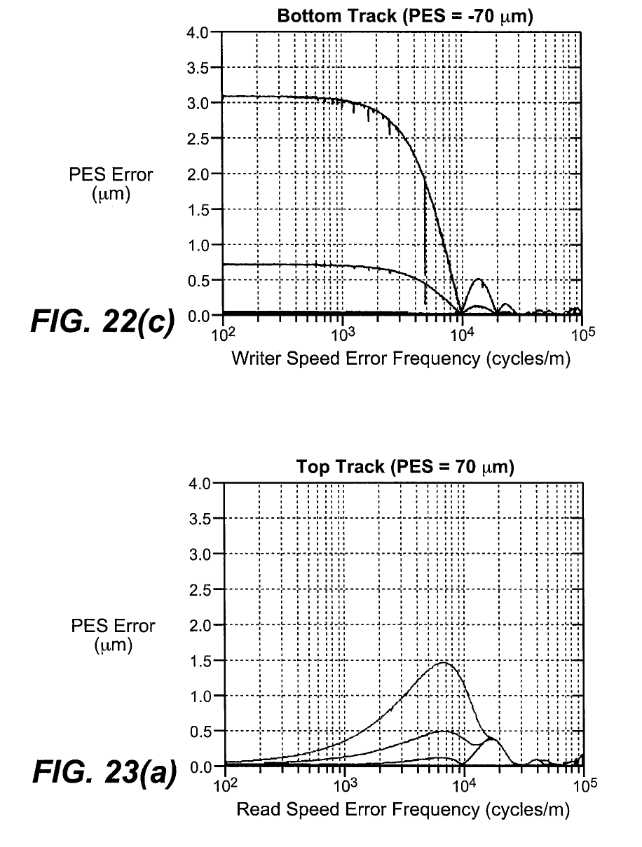

Extending from FIG. 19 which assumes servo writer speed error at a low frequency, FIGS. 22a to 22c show graphically the improvement of PES error due to a servo writer speed variation of 1% at different frequencies for the top, middle, and bottom tracks. In FIGS. 22a to 22c, the top and bottom servo are stamped simultaneously.

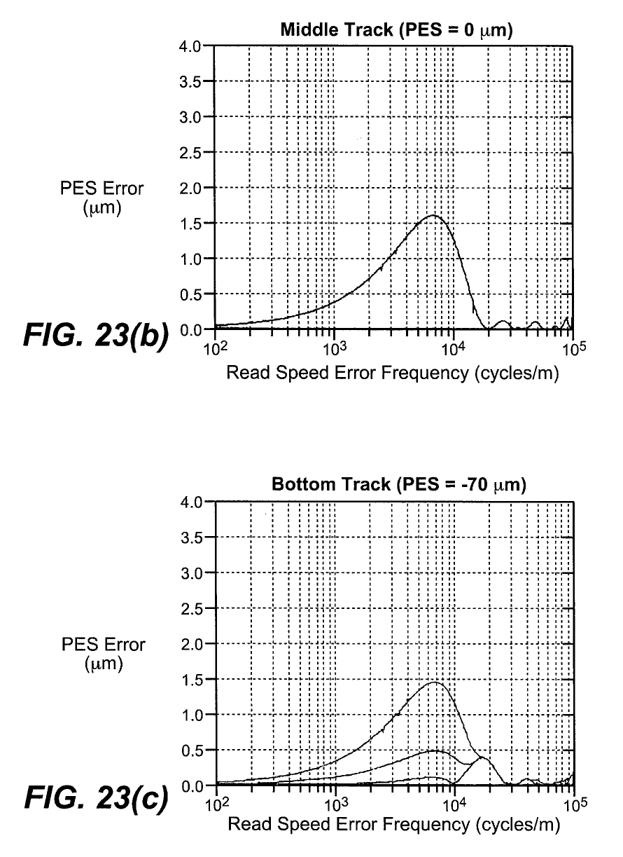

Besides the improvement of PES error due to the servo writer speed variation, this method also improves the PES error due to the tape drive speed variation by a factor of 10. FIGS. 23a to 23c show graphically the improvement of PES error due to the tape drive speed variation of 1% at different frequencies. In FIGS. 23a to 23c, the top and bottom servo are both written with perfect dimension accuracy. FIGS. 23a to 23c show the performance of the curved complementary writer is not as good as that of the straight complementary writer. Depends on the amplitude and frequency of the servo writer speed variation and tape drive speed variation, one can modify the curve equation and design a specific curve for a different requirement.

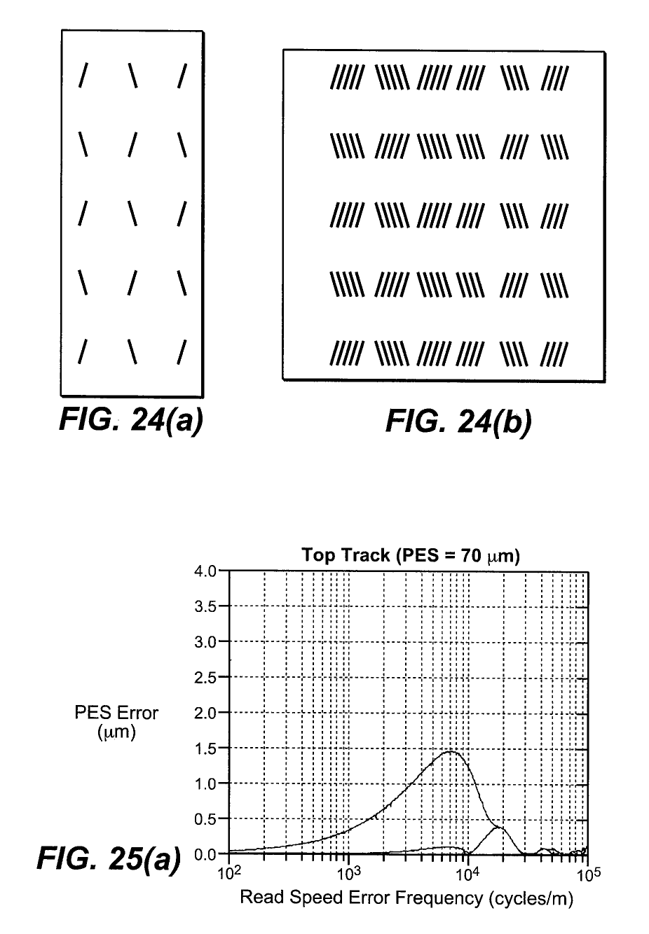

The present complementary servo writer can also be applied to a servo writer that writes three or more servo stripes simultaneously (see U.S. Pat. Nos. 6,842,305 and 6,879,457). For example, FIG. 24a shows the present straight complementary servo writers and resulting pattern, see FIG. 24b applied to a three-stripe servo writer. Since the PES error due to servo writing speed error is zero, one can focus on the PES error due to tape drive speed variation.

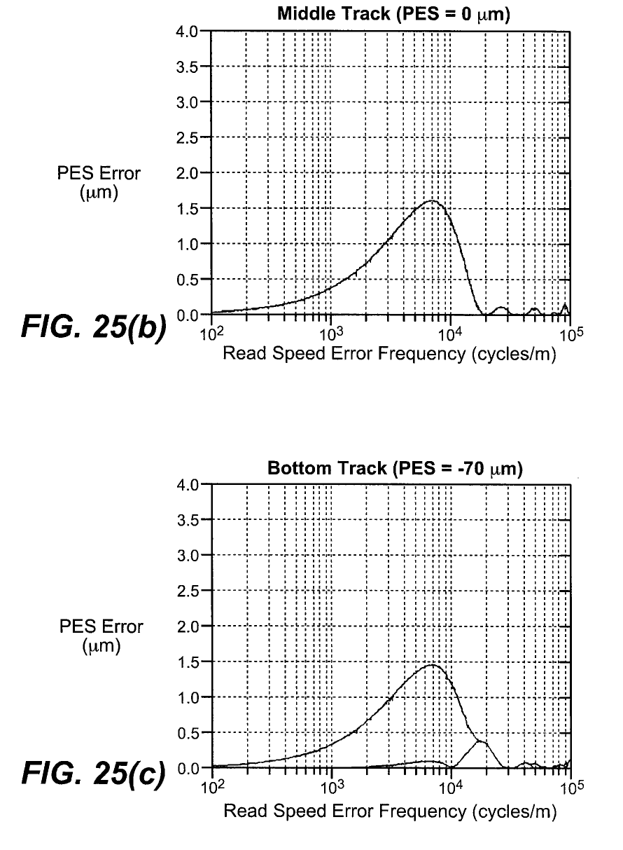

FIGS. 25a to 25c show graphically the improvement of PES error due to the tape drive speed variation of 1% at different frequencies for the top, bottom, and middle tracks. In FIGS. 25a to 25c, the top and bottom servo are both written with a three stripe servo writer. Again, there is an improvement of PES error by a factor of more than 10.

In accordance with the invention, there is provided: reduction of the written-in PES error caused by tape speed variation in the servo writers and reduction of the PES error caused by tape speed variation in the tape drive. Compared to prior approaches, this method does not lose PES samples per frame. In one embodiment, it can write a servo format similar to the LTO servo format, including the 5544 pattern, LPOS encoding, and band ID timing offset, therefore no change is required for ASIC, and allow the LTO drives to be backward compatible. In another embodiment, it can write the current LTO servo format. In another embodiment using curved servo stripes combined with the complementary servo writer pair, the written-in PES error caused by servo writer speed variation can be canceled to near zero.

### Chevron Pattern for Servo Writer

This portion of this disclosure is of a method and apparatus to reduce PES calculation error to nearly zero by using in some embodiments a curved (or chevron shaped) complementary servo writer pair. This improves the above described technique by combining the complementary servo writer pairs which write separate servo tracks, into a single servo writer transducer that writes one servo track having the written-in timing cancellation characteristic embodied within it. In addition to the writing technique, there is a set of servo read transducers for the position signal detection system that read the servo track in a method to reduce the written-in timing error.

In one embodiment, a servo format very similar to the current LTO format is written, therefore making it detectable by current PES detection ASIC (Application-Specific Integrated Circuit) devices in the tape drive. Another advantage of the present complementary servo writing method is that it not only reduces the PES detection error due to the servo writing variations, but it also reduces the PES detection error due to the drive read speed error by a factor of 10.

This curved writer feature improves the servo format to reduce the PES calculation error due to servo writer speed variation and tape drive speed variation, in order to achieve high track densities for future generations of drives with a minimal modification or without changing the current defined LTO format and assuring four PES samples per frame without introducing time delays. In addition, speed variation error reduction is enhanced by placing the cancellation transducers close together, position signal redundancy is enhanced with four concurrent position signals, and detection channel noise is reduced by providing more peak measurements within the servo frame.

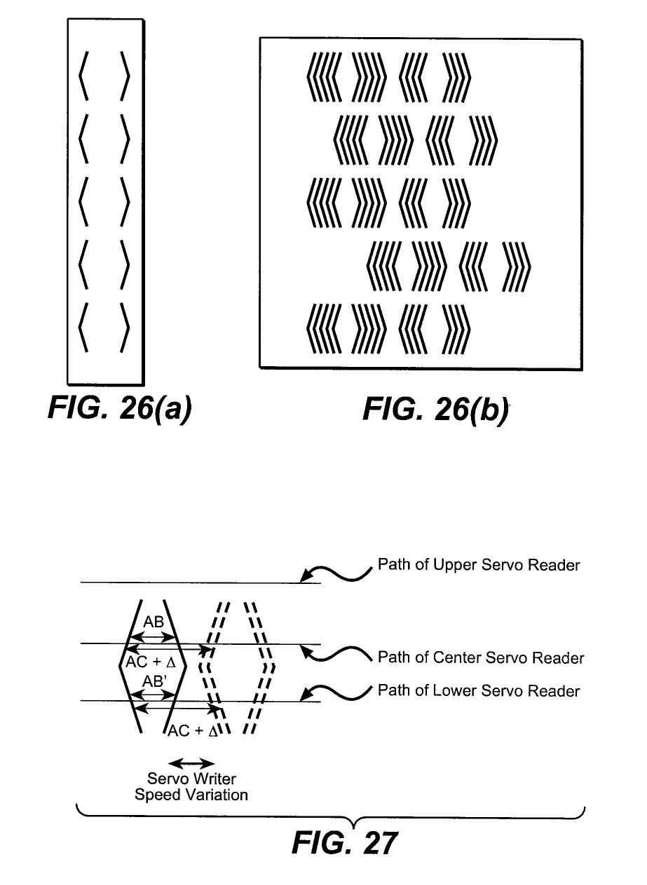

Thus there is disclosed here a technique to reduce written-in speed error in the servo track. This portion of the present disclosure provides a servo track geometry and servo read head configuration to reduce written-in speed variation with a single servo track. This provides a servo track format employing a chevron pattern that has the capability to cancel servo writer speed variation. FIG. 26a shows in a simplified view the servo writer to do this, and FIG. 26b shows the resulting servo frame as written on the tape. Averaging two separate servo tracks is not required for this feature. Two read transducers (heads) are required in the tape drive to read and detect this servo track to cancel the written in speed variation. Consequently, a tape drive employing this technique is provided with at least two servo read transducers (sensors) laterally separated from one another by half the total index positions of the servo head. To acquire all the index positions on the servo track in the tape drive, a third read transducer is provided at a lateral spacing of half the total index positions away from one of the first two transducers.

FIG. 27 shows a part of the present servo pattern of FIG. 26b written on tape, and the paths of the servo readers in the tape drive that read the servo track to detect the position signal. Two of the three servo readers are each positioned to simultaneously read the servo pattern. The upper, center and lower readers are each separated by half the total index positions. When the lower two readers have covered all positions where they are simultaneously over the servo track, the lower servo reader leaves the servo track, and the upper servo reader enters the track to acquire the rest of the index positions. The center servo reader thus visits all index positions in the upper and lower half of the servo track.

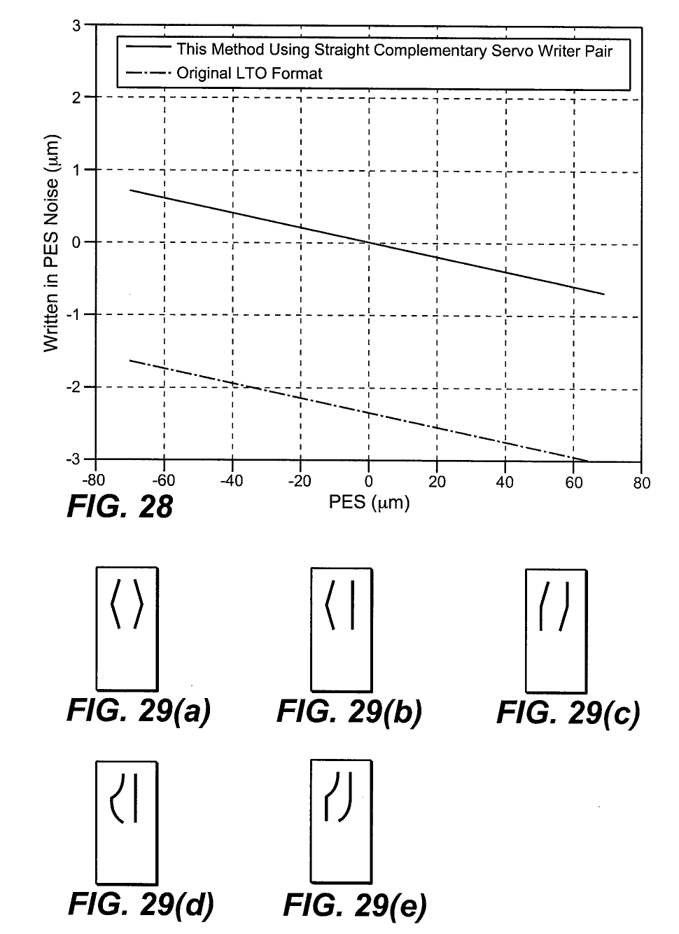

This servo format shown in FIG. 26b appears different from that of the conventional servo track LTO format, but it employs the same position detection channel (circuitry) in the corresponding tape drive. The formatted sequence of transitions written into the servo track can be maintained as well as the method of longitudinal data encoding. Thus the same detection channel in the tape drive can be employed to detect the position signal and longitudinal data. FIG. 28 illustrates graphically the reduction in written-in PES noise using this method.

The chief difference in using this format is it requires at least four servo track detection channels in the tape drive to detect the servo position signal and cancel the written-in speed error due to the servo writer. Multiplexing the read signal from the preamplifiers into the detection channels is also needed. In return, greater noise reduction is accomplished since more peaks are detected and averaged in the computation of the position signals.

FIGS. 29a to 29e show more examples of complementary servo writer pairs.

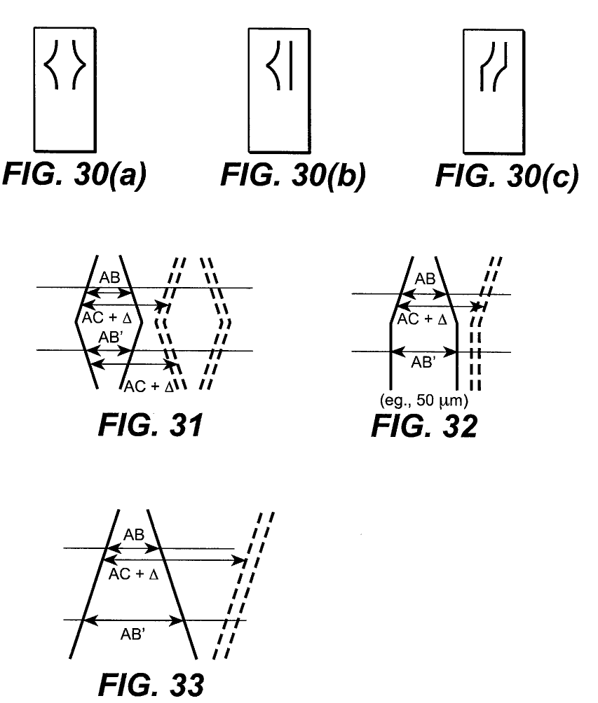

FIGS. 30a to 30c show further examples of complementary servo writer pairs; notice the similarity to FIGS. 29a to 29c. Some stripes are intentionally curved in an attempt to cancel all written-in PES error caused by servo writer speed variation. The drawback is that the PES calculation gain is not a constant from the top to bottom servo tracks.

### Fixed Interval Patterns for the Servo Writer

Several methods are disclosed following which remove all of the written-in speed variations of the servo writer when computing the lateral position signal from the servo track. These methods all make use of intervals measured in the servo track that are fixed distance intervals, independent of lateral position of the servo writer head, and determined by the geometry of the servo writer head, and variable distance intervals determined by the lateral position of the servo read head or heads relative to the servo track. The fixed distance measurements provide the data to normalize the variable distance measurements for variations in read tape speed when detecting the lateral position from the servo track. Since these are timing-based measurements, normalization to read tape speed is necessary. By providing and measuring a fixed distance interval in the servo track format that is determined by the servo writer head geometry, the servo writer tape speed variations are completely removed from the read tape speed normalization and the resulting lateral position signal computations.

All of these methods may make use of a calibration process when a tape (e.g., tape cartridge) is first loaded into the tape drive to remove any tolerance in the fixed interval feature of the servo track and the servo read head configuration. The calibration process may include moving the tape at a constant speed while reading the servo track, and measuring the average servo frame interval shown below in FIGS. 31, 32 and 33 as interval AC. Using well understood techniques, the interval AC can be determined with high accuracy and no servo writer speed variability, and can be used to calibrate the fixed tolerances resulting from servo writer head geometry and the servo read head configuration.

The various methods use different configurations for the servo writer head, resulting in different servo track patterns, and they may use different configurations for the read (detection) system to read the servo tracks and detect lateral position. The first of these embodiments is shown in FIG. 31. The lateral position signal is calculated by (AB−AB′)/(AB+AB′), where (AB+AB′) is a constant interval determined by the servo writer head geometry, such as 50 μm. Using this PES detection scheme, there is no PES error due to written-in speed variation since AC, the interval to the next servo frame, is not used. This method uses three servo read heads in the tape drive to acquire all index positions across the servo track, and two of the three heads simultaneously read the servo track at any given index position. The index positions are selected so that none exists with the center read head located at the apex of the chevron pattern. The three read heads are laterally separated by half the total index position range, and when the lower head leaves the servo track at the bottom, the upper read head enters the servo track at the top. Thus the center servo read head visits all the index position on the servo track.

Another embodiment is shown in FIG. 32, where the top half of the servo pattern is the same as the previously shown chevron pattern, and the bottom half of the servo pattern has only vertical stripes. The PES ratio is then calculated by AB/AB′, where AB′ is a constant, such as 50 μm. Using this PES detection scheme, there is no PES error due to written-in timing variation since interval AC is not used.

Another embodiment is shown in FIG. 33, where the servo pattern is the same as the current LTO servo pattern. The PES ratio is then calculated by (AB+AB′)/(AB−AB′), where (AB−AB′) is a constant, such as 20 μm. Using this PES detection scheme, there is no PES error due to written-in timing variation since AC is not used. Furthermore there is no dead-zone because there are no bends within a servo stripe.

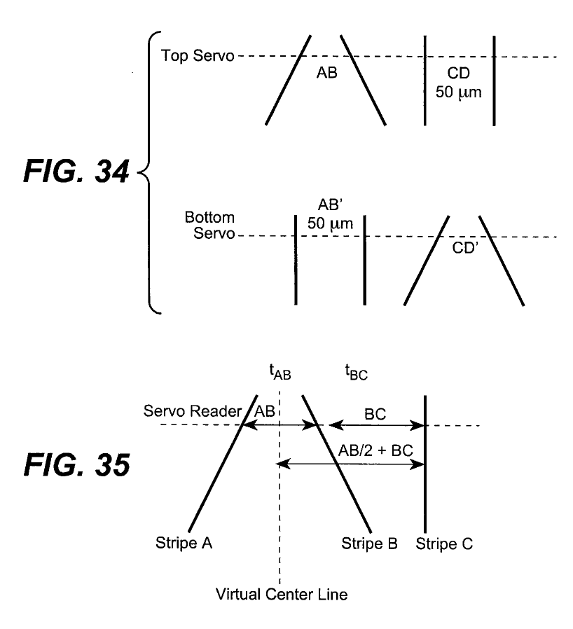

“VII” pattern: An alternative to FIG. 32 is to separate the top half servo pattern and bottom half servo pattern into two adjacent servo bands, as shown in FIG. 34. The PES ratio can be similarly calculated by AB/AB′, where AB′ is a constant, such as 50 μm. Furthermore, the angled stripes and vertical stripes are alternated within the same servo band, so the PES ratio can be calculated by AB/CD, where CD is a constant, such as 50 μm. Using this configuration, there is no PES error due to written-in speed error. There is also no PES error due to read speed variation in AB/AB′ since AB and AB′ are centered. For every full servo frame of A, B, C, and D bursts, there are two PES signal available, one from top servo band, and another one from bottom servo band. The difference of these two PES signal represents the reader-to-reader distance error, tape dimension change, and lateral tape motion between the AB and CD subframes.

“VI” pattern: Another embodiment similar to that of FIG. 34 is shown in FIG. 35, by stamping three servo stripes A, B, and C simultaneously on the tape. Notice that these three stripes have three different azimuth angles, and hence are different from the approaches of U.S. Pat. No. 6,842,305 B2 and U.S. Pat. No. 6,879,457 B2. (These require two stripes with the same geometry or azimuth angle being stamped simultaneously.) However, in accordance with the present invention, the three stripes are stamped together with three different azimuth angles, and the PES is calculated by the following equation: AB/(BC+AB/2)=t_{AB}/(t_{BC}+t_{AB}/2). (BC+AB/2) can be interpreted as the distance from the virtual centerline of A and B stripes to the C stripe. In this servo format and PES detection equation, there is no PES error due to written-in speed variation. The PES is calculated from a single servo channel. Every full servo frame of A, B, and C bursts produces one PES signal.

In the VI pattern shown in FIG. 35, the third stripe does not need to be vertical. All three stripes can have azimuth angles or curves, and the PES ratio will be calculated from t_{AB} and t_{BC} using a different equation according to the geometry.

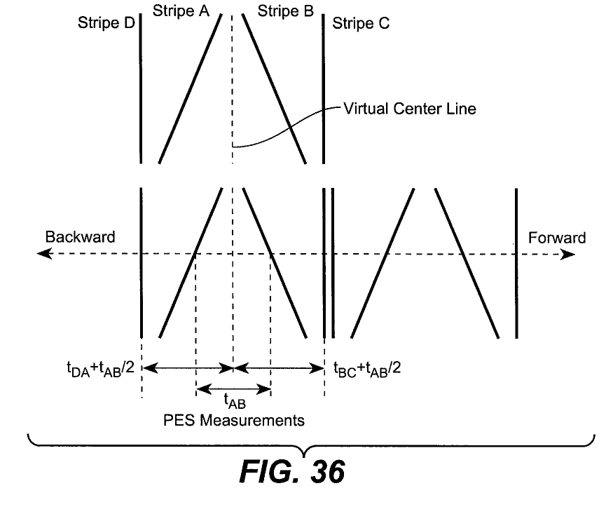

“IVI” pattern: Another embodiment similar to that of FIG. 35 is shown in FIG. 36, by stamping four servo stripes D, A, B, and C simultaneously on the tape. The first and last stripes, D and C, are vertical and the second and third stripes, A and B, are at opposite azimuth angles, and hence are different from the approaches of U.S. Pat. No. 6,842,305 B2 and U.S. Pat. No. 6,879,457 B2. The computation of PES is the same as in the “VI” pattern method, but two intervals from the virtual centerline of the A and B stripes are available for computing the PES. One of these two intervals is selected for the PES calculation depending on servo read direction. This minimizes time delay in computing PES by providing all measurements for PES as soon as the AB measurement is complete, for both directions. The PES is calculated by one of the following equations, depending on direction: backward, AB/(BC+AB/2)=t_{AB}/(t_{BC}+t_{AB}/2) or forward, AB/(DA+AB/2)=t_{AB}/(t_{DA}+t_{AB}/2). (BC+AB/2) and (DA+AB/2) can be interpreted as the distance from the virtual centerline of A and B stripes to the C stripe or the D stripe respectively.

In the IVI pattern shown in FIG. 36, the first and fourth stripes do not need to be vertical. All stripes can have azimuth angles or curves, and the PES ratio will be calculated from t_{AB}, t_{BC} and t_{DA} using a different equation according to the geometry.

The present chevron servo patterns provide in each servo track the capability for written-in PES error reduction caused by tape speed variation in the servo writers; provide in each servo track, the capability to reduce the PES error caused by tape speed variation in the tape drive; maintain full dual servo channel redundancy while providing the speed error reduction; provide four servo channel redundancy without speed error reduction; and reduce detected position signal noise by doubling the number of peaks used to compute the position signal for each servo track.

The resulting servo pattern format is similar to the conventional LTO servo format, in terms of the 5544 pattern, LPOS encoding, and band ID timing offset, therefore no change is required in the tape drive servo tracking circuitry, and this allows the associated LTO tape drives to be backward compatible. The presently disclosed servo frame format requires provision of two additional servo detection channels (which are each conventional in their configuration) in the corresponding tape drive servo tracking circuitry.

This disclosure is illustrative and not limiting; further embodiments and modifications will be apparent to those skilled in the art in light of this disclosure and are intended to fall within the scope of the appended claims.

We claim:

1. A method of writing positioning information on a magnetic recording tape, comprising the acts of:
providing the magnetic recording tape;
writing the positioning information on the magnetic recording tape;
wherein the positioning information as written includes at least a pair of servo bands, each servo band including a plurality of stripes, the stripes in a first of the servo bands being arranged complementary to the stripes in a second of the servo bands.

2. The method of claim 1, wherein the tape conforms to the Linear Tape Open format.

3. The method of claim 1, the positioning information including five servo bands, with a data band region being located between any two adjacent servo bands.

4. The method of claim 1, wherein the stripes are arranged so that upon reading the servo bands, position error is reduced compared to that of the Linear Tape Open format.

5. The method of claim 1, wherein at least some of the stripes are curved.

6. The method of claim 1, wherein at least some of the stripes are straight.

7. The method of claim 5, wherein at least some of the stripes are straight.

8. The method of claim 1, wherein stripes in the first servo band are offset relative to stripes in the second servo band.

9. The method of claim 4, wherein the stripes are arranged so that upon reading the servo bands, when position signals from two adjacent servo bands are averaged, the position error is reduced.

10. The method of claim 1, wherein in each pair of servo bands, the stripes in the first servo band are arranged to lie at an angle to corresponding stripes in the second servo band.

11. The method of claim 2, wherein the stripes are arranged to allow, upon reading the servo bands, detection of the LTO 5-5-4-4 pattern, LPOS encoding, and band identification.

12. The method of claim 1, wherein the act of writing comprises:
providing two server writer assemblies; and
separately energizing each assembly.

13. The method of claim 1, wherein the act of writing comprises providing adjacent servo band writers arranged to be mirror images of one another in a direction perpendicular to a direction of movement of the tape during writing.

14. The method of claim 1, wherein the act of writing comprises providing adjacent servo band writers arranged to be mirror images of one another in a direction parallel to a direction of movement of the tape during writing.

15. The method of claim 1, wherein at least some of the stripes are V-shaped.

16. The method of claim 15, wherein the stripes are arranged in pairs, and in each pair one stripe is straight and one is V-shaped.

17. The method of claim 15, wherein the stripes are arranged in pairs, and in each pair both stripes are V-shaped.

18. The method of claim 5, wherein the stripes are arranged in pairs, and in each pair one stripe is straight and one is curved.

19. The method of claim 5, wherein the stripes are arranged in pairs, and in each pair both stripes are curved.

20. The method of claim 1, wherein the act of writing comprises writing two adjacent servo bands at the same time.

21. The method of claim 20, wherein the act of writing comprises:
providing offset, in a direction of movement of the tape during the writing, between stripes in adjacent servo bands.

22. The method of claim 1, wherein the act of writing comprises:
providing a servo writer having three write elements arranged in a row parallel to a direction of movement of the tape during the writing.

23. A magnetic tape product having positioning information written therein by the method of claim 1.

24. The magnetic tape product of claim 23, further including a cartridge housing the magnetic tape.

25. Apparatus for writing positioning information on a magnetic recording tape, comprising:
a tape drive mechanism for moving the tape; and
a servo writer assembly arranged adjacent the tape; wherein the servo writer assembly includes a plurality of pairs of servo writers, each servo writer pair being adapted to write a servo band on the tape, each servo band including a plurality of stripes, the servo writer pairs being arranged so that each pair is complementary to the pair writing an adjacent servo band.

26. A magnetic tape product with positioning information magnetically recorded thereon, the positioning information comprising:
at least a pair of servo bands, each servo band including a plurality of stripes, the stripes in a first of the servo bands being arranged, complementary to the stripes in the second of the servo bands.

27. A method comprising the act of reading the positioning information magnetically recorded on the magnetic tape product of claim 26.

28. A magnetic tape drive, comprising:
a tape drive mechanism for moving the tape; and
a servo sensor assembly arranged adjacent the tape; wherein the servo sensor assembly includes a pair of servo sensors, each sensor being arranged to read a servo band on the tape; and
further including a servo mechanism coupled to the servo sensors and which averages the position error signals from the servo sensors, and thereby moves a position of the tape.

29. A method of writing positioning information on a magnetic recording tape, comprising the acts of:
providing the magnetic recording tape;
writing the positioning information on the magnetic recording tape;
wherein the positioning information as written includes at least one servo band, each servo band including a plurality of stripes, the stripes in each of the servo bands being shaped in complementary top half and bottom half portions, and at least some of the stripes being chevron-shaped.

30. The method of claim 29, wherein the tape conforms to the Linear Tape Open format.

31. The method of claim 29, the positioning information including a group of five servo bands, a data band region being located between any two adjacent servo bands.

32. The method of claim 29, wherein the stripes are shaped so that upon reading the servo bands, position error is reduced compared to that of the Linear Tape Open format.

33. The method of claim 29, wherein at least some of the chevron-shaped stripes are curved.

34. The method of claim 29, wherein at least some of the stripes are straight.

35. The method of claim 33, wherein at least some of the stripes are straight.

36. The method of claim 29, wherein there is a plurality of servo bands, and the stripes in a first servo band are offset relative to stripes in an adjacent servo band.

37. The method of claim 32, wherein the stripes are shaped so that upon reading the servo band, when position signals from two adjacent servo readers reading the same servo band are averaged, the position error is reduced.

38. The method of claim 30, wherein the stripes are arranged to allow, upon reading the servo bands, detection of the LTO 5-5-4-4 pattern, LPOS encoding, and band identification.

39. A magnetic tape product having positioning information written therein by the method of claim 29.

40. The magnetic tape product of claim 39, further including a cartridge housing the magnetic tape.

41. Apparatus for writing positioning information on a magnetic recording tape, comprising:
a tape drive mechanism for moving the tape; and
a servo writer assembly arranged adjacent the tape; wherein the servo writer assembly includes a plurality of pairs of servo writers, each servo writer pair being adapted to write a servo band on the tape, each servo band including a plurality of stripes, the servo writer pairs being arranged so each of the servo bands is shaped in complementary top and bottom portions, and at least some of the stripes being chevron-shaped.

42. A magnetic tape product with positioning information magnetically recorded thereon, the positioning information comprising:
at least a pair of servo bands, each servo band including a plurality of stripes, the stripes in each servo band being arranged in complementary pairs of stripes, and at least some of the stripes being chevron-shaped.

43. A method comprising the act of reading the positioning information magnetically recorded on the magnetic tape product of claim 42.

44. A method of writing positioning information on a magnetic recording tape, comprising the acts of:
providing the magnetic recording tape;
writing the positioning information on the magnetic recording tape;
wherein the positioning information includes at least at least one of servo band, each servo band including a plurality of stripes, the stripes in each servo band being arranged in groups of three or four, each group lying perpendicular to a direction of the tape movement, and two stripes of each group lying at an angle to each other.

45. The method of claim 44, a fourth stripe of each group lying perpendicular to the direction of tape movement.

46. A magnetic tape product having positioning information written thereon by the method of claim 44.

47. The magnetic tape product of claim 46, further including a cartridge housing the magnetic tape.

48. A magnetic tape product with positioning information magnetically recorded thereon, the positioning information comprising:
at least one servo band, each servo band including a plurality of stripes, the stripes in each servo band being arranged in groups of three or four, one stripe of each group lying perpendicular to a direction of the tape movement, and two stripes of each group lying at an angle to each other.

49. A method compromising the act of reading the positioning information magnetically recorded on the magnetic tape product of claim 48.

50. A method of writing positioning information on a magnetic recording tape, comprising the acts of:
providing the magnetic recording tape;
writing the positioning information on the magnetic recording tape;
wherein the positioning information includes at least one servo band, each servo band including a plurality of stripes, the stripes in each servo band being arranged in groups of three, each group lying perpendicular to a direction of the tape movement, and all three stripes of each group having different geometry from each other.

51. The method of claim 50, wherein all three stripes are straight.

52. The method of claim 51, one stripe of each group lying perpendicular to a direction of the tape movement, and two stripes of each group lying at an angle to each other.

53. A magnetic tape product having positioning information written thereon by the method of claim 50.

54. The magnetic tape produce of claim 53, further including a cartridge housing the magnetic tape.

55. A magnetic tape product with positioning information magnetically recorded thereon, the positioning information comprising:
at least one servo band, each servo band including a plurality of stripes, the stripes in each servo band being arranged in groups of three, and all three stripes of each group having different geometry from each other.

56. A method compromising the act of reading the positioning information magnetically recorded on the magnetic tape product of claim 55.

57. A method of writing positioning information on a magnetic recording tape, comprising the acts of:
providing the magnetic recording tape;
writing the positioning information on the magnetic recording tape;
wherein the positioning information includes at least one servo band, each servo band including a plurality of stripes, the stripes in each servo band being arranged in groups of four, the first and last stripes in each group lying perpendicular to a direction of the tape movement, and the second and third stripes in each group lying at an angle to each other and to an axis perpendicular to the direction of tape motion.

58. The method of claim 57, wherein all four stripes are straight.

59. The method of claim 58, the first and fourth stripes lying perpendicular to a direction of the tape movement, and the other two stripes lying at an angle to each other.

60. A magnetic tape product having positioning information written thereon by the method of claim 57.

61. The magnetic tape product of claim 60, further including a cartridge housing the magnetic tape.

62. A magnetic tape product with positioning information magnetically recorded thereon, the positioning information comprising:
at least one servo band, each servo band including a plurality of stripes, the stripes in each servo band being arranged in groups of four, and the first and fourth stripes in each group having the same geometry and the second and third stripes in each group having different geometry from each other.

63. A method compromising the act of reading the positioning information magnetically recorded on the magnetic tape product of claim 62.
